(19) United States
(12) Patent Application Publication
(10) Pub. No.: US 2004/0190978 A1
(43) Pub. Date: Sep. 30, 2004

(54) Pivoting joint pivotally joining a brake head to a brake beam

(76) Inventor: Jorge Alberto De La Fuente-Farias, Monterrey (MX)

Correspondence Address: ABELMAN, FRAYNE & SCHWAB, 150 East 42nd Street, New York, NY, 10017-5612, US

(21) Appl. No.: 10/395,796

(22) Filed: Mar. 24, 2003

(51) Int. Cl. F16D 1/12

(52) U.S. Cl. 403/119

(57) ABSTRACT

A pivoting joint for pivotally joining a brake head to a brake beam of a railway car allows the brake head to modify its radial and lateral direction with a controlled degree of rotation with respect to a bogie wheel, allowing the brake shoe to adapt to the wheel contour, and achieving an adequate force distribution along the brake shoe, and thus optimizing the utilization of the brake shoe material.

### CROSS-REFERENCE TO RELATED APPLICATIONS

This invention is related to co-pending U.S. application Ser. No. 09/668,483, filed Sep. 25, 2000, which is incorporated herein by reference.

### BACKGROUND OF THE INVENTION

1. Field of the Invention

The present invention is related to brake head assemblies for using in brake beams of railway cars, and more particularly to a pivoting joint for pivotally joining a brake head to a brake beam of a railway car by which an adequate force distribution along the brake shoe and an adequate contact between the brake shoes and the railway car bogie wheels are achieved.

2. Description of the Related Art

Most railroad freight cars and other transportation apparatus use a mechanism called brake rigging, classified generally as either a Body Mounted System (BMS) with an actuator on the car platform; a Truck Mounted System Direct Acting (TMS-DA) with an actuator on the beam; or a Truck Mounted System Indirect Acting (TMS-IA) with an actuator on the transportation apparatus, such as a truck, acting through levers on standard brake beams.

Generally, there is an air reservoir mounted on the car body, which provides pressurized air to at least one brake cylinder. In a BMS, the brake cylinder, in turn, supplies a mechanical force through a system of rods and driving levers to a truck driving lever system, usually consisting of two driving levers and a connecting rod. The driving levers move brake beams, which apply force to the treads of the wheels through interchangeable friction blocks or brake shoes, retarding the rotation of the wheels.

The conventional TMS brake rigging includes two brake beams per truck, at least one brake cylinder assembly per truck, and a driving lever or linkage assembly connected between the brake beams and the cylinder assembly.

There are many brake beam types that may be used in combination with the above-referred conventional brake rigging. One of the most commonly used brake beam types comprises: a compression member; a generally “V”-shaped tension member having its ends coupled to the ends of the compression member; a brake head linked to each end of the compression and/or tension members, each comprising a brake shoe carrier having a brake shoe; two end extensions, each linked at each end of the tension and/or compression member, or hanging means, by which the brake beam is coupled to the bogie of a railway car; and a fulcrum assembly attached to the compression member and tension member, so that the fulcrum remains between the tension and compression members. On the most common TMS-DA, there is also a cylinder assembly mounted in one of the beams, connected to its compression member, while the opposite beam in the same truck has a fulcrum or linkage means on the compression member to transfer the force of the cylinder to both beams, with an automatic double acting slack adjuster element between them, that extends via a trigger to compensate for the wear of the brake shoes.

Normally, the brake heads are fixedly linked to the brake beam by means of bolts passing through perforations located at the ends of the brake beam and through perforations located at the brake heads. Also, the brake heads may be linked to a brake beam by welding the brake head directly to the ends of the brake beam, or are integral to the beam ends as is the case of the cast beams.

The looseness between the extensions of the brake beam and its guides, which is necessary in order to compensate for the movements of the truck components when in operation, causes the brake beam to hang from the truck, so that its non-braking position does not point to the center of the wheel. Furthermore, during the braking operation, due to existent fixed joints between the extensions of the brake beam and its truck guides, between the brake heads and the wheels during the braking operation, and between the brake head and the brake beam, there is a double restriction that somehow buckles the displacement of the beam in the truck guides as well as its self-alignment towards the wheel center, so that the forces applied through the brake head are not transmitted uniformly along the brake shoe, thus producing a non-uniform and incomplete wear of the useful material of the brake shoes, which is a waste of useful material that could be properly used, and therefore, it is necessary to frequently change the brake shoe material which is a waste of time and money. In many occasions this uneven taper wear leaves the shoe material at the bottom of the shoes in as-new condition, while the top has already reached the condemnable limits, thus producing a material waste of approximately 50%.

In extreme cases, the material of the brake shoe is so worn at some points that the metal of the brake shoe carrier comes in direct contact with the corresponding bogie wheel, damaging the brake shoe carrier as well as the wheel.

It is also a common problem that, as the cars run through their cycle life, the components of its brake rigging system gradually wear out, aggravating the conditions of the beam hanging and buckling as referred above, thus further reducing the useful life of the brake shoes as the car ages.

Therefore, it would be desirable to have a brake head that is allowed to pivot around its own axis and thus to completely adapt to the wheel thread.

Considering the above referred problems, the present applicant has developed in the present invention a pivoting joint for pivotally joining a brake head to a brake beam which pivotally joins the brake head to the brake beam in order to allow the brake head to modify its radial direction with a controlled degree of rotation with respect to the wheel, thus allowing the brake shoe to adapt to the wheel thread and achieving an adequate force distribution along the brake shoe.

The present invention provides a pivoting joint for pivotally joining a brake head to a brake beam, and comprises: brake beam pivoting means for pivotally joining a brake head; and brake head pivoting means for pivotally joining the brake head to the brake beam pivoting means.

With the pivoting joint of the present invention, all the useful material of the brake shoe is totally used, thus avoiding frequent changes of the brake shoe material, which helps to achieve great money savings in view of the high maintenance costs caused by the frequent changes, and avoiding the waste of useful brake shoe material that still could be used if the thickness of the remaining material were uniform.

Furthermore, thanks to the brake head degree of rotation, torsional forces induced by the levers at certain angles during operation are reduced, thus extending the life of pins, levers, pocket guides, and the beam itself, by avoiding the buckling of the elements, and allowing the rigging system to apply a uniform force to all wheels on the transportation apparatus, such as a truck.

### BRIEF SUMMARY OF THE INVENTION

It is therefore a main object of the present invention to provide a pivoting joint for pivotally joining a brake head to a brake beam.

It is also a main object of the present invention to provide a pivoting joint for pivotally joining a brake head to a brake beam, which allows the brake head to modify its radial direction with a controlled degree of rotation with respect to the brake beam by self-adjusting about one axis with respect to the wheel, thus transferring optimum braking forces to the wheels by preventing the buckling of its different elements, such as the end extensions on the truck guides and the lever on the strut, aiming to correct common brake problems in low braking applications and hand brake applications, for all types of brake rigging mechanisms (BMS & TMS).

It is a further object of the present invention to provide a pivoting joint for pivotally joining a brake head to a brake beam, by which a uniform force distribution is achieved along the brake shoe, thus allowing the brake shoe material of the brake head to adapt to the wheel thread as the material of the brake shoe is worn.

It is still another object of the present invention to provide a pivoting joint for pivotally joining a brake head to a brake beam, by which all the useful material of the brake shoe is totally used, thus avoiding frequent changes of the brake shoe material.

It is still another object of the present invention to provide a pivoting joint for pivotally joining a brake head to a brake beam, by which a uniform and complete wear of all the brake shoe material is achieved.

It is another object of the present invention to provide a pivoting joint for pivotally joining a brake head to a brake beam that reduces the torsional forces induced by the levers at certain angles during operation, thus extending the life of pins, levers, pocket guides, and the beam itself, by avoiding the buckling of the elements, and allowing the rigging system to apply a uniform force to all wheels on the transportation apparatus, such as a truck.

These and other objects and advantages of the pivoting joint for pivotally joining a brake head to a brake beam of the present invention will become apparent to those persons having ordinary skill in the art, from the following detailed description of the embodiments of the invention, which will be made with reference to the accompanying drawings.

### BRIEF DESCRIPTION OF THE SEVERAL VIEWS OF THE DRAWINGS

Preferred embodiments of the invention are disclosed hereinbelow with reference to the drawings, wherein:

FIG. 1 is a front view of a brake beam having the pivoting joint for pivotally joining a brake head to a brake beam of the present invention.

FIG. 2 is a front partial close-up view of the pivoting joint for pivotally joining a brake head to a brake beam of the present invention in accordance with a preferred embodiment thereof.

FIG. 3 is a front partial close-up view of the pivoting joint for pivotally joining a brake head to a brake beam of the present invention in accordance with another preferred embodiment thereof.

FIG. 4 is a front view of a cast brake beam having the pivoting joint for pivotally joining a brake head to a brake beam of the present invention integral to the brake beam ends.

### DETAILED DESCRIPTION OF THE INVENTION

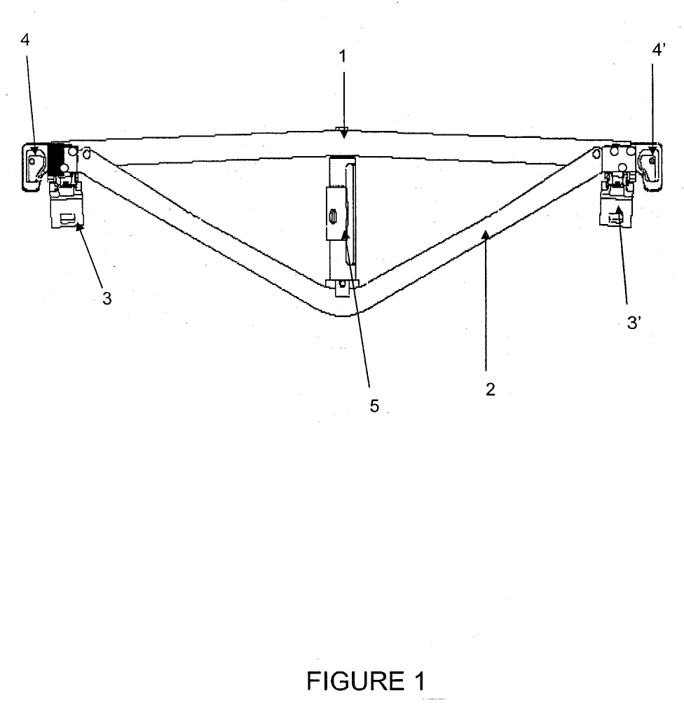

As shown in FIGS. 1-4, the present invention can be used in various transportation apparatus which employ brake systems, such as the brake system described in co-pending U.S. application Ser. No. 09/668,483, filed Sep. 25, 2000, which is incorporated herein by reference. Although described herein with reference to an example embodiment for a railroad car, the present invention may be implemented in various transportation apparatus not limited to railroad cars, such as trucks and other vehicles using brake systems.

Referring to FIG. 1, a typical brake beam comprises: a compression member 1, a generally “V” shaped tension member 2 having its ends coupled to the ends of the compression member 1, each including a first longitudinal side, a second longitudinal side, a first end, and a second end; a brake head 3, 3′ linked to each end of the compression and/or tension member; two end extensions 4, 4′ or hanging means by which the brake beam is coupled to the bogie of a railway car, and a fulcrum 5 assembled, cast, or welded to the compression member 1 and the tension member 2.

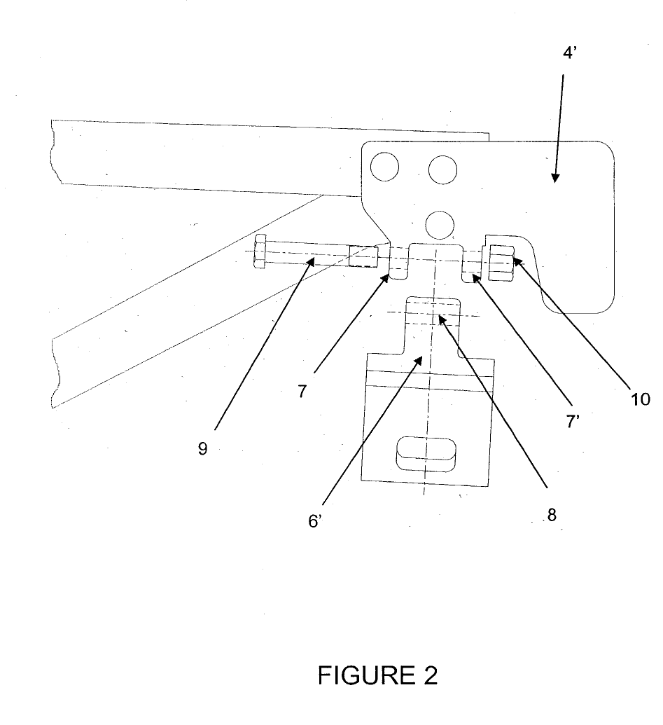

As shown in FIG. 2, a typical brake head comprises linking means for linking the brake head to the brake beam, with the linking means having a pair of surfaces 6, 6′ and brake shoe material, including a left inclined superior surface 6 (not shown) on an opposite side of the linking means with respect to a right inclined superior surface 6′.

The pivoting joint for pivotally joining a brake head to a brake beam for allowing the brake head to pivot about its own axis (angular rotation) with a controlled degree of freedom with respect to the brake beam will be described in accordance with a preferred embodiment thereof referring to a typical brake beam and brake head, wherein the pivoting joint for pivotally joining a brake head to a brake beam comprises:

brake beam pivoting means for pivotally joining a brake head, comprising a pair of bushings 7, 7′ each welded to a brake beam extension 4;

brake head pivoting means for pivotally joining the brake head to the brake beam pivoting means comprising a bushing 8 welded along the brake head's inclined superior surfaces 6, 6′ and lodged between the bushings 7, 7′ of the brake beam pivoting means; and

a screw 9 passing through the bushings 7, 7′ of the brake beam pivoting means and brake head pivoting means 8, and secured by a nut 10 thus pivotally linking the brake head to the brake beam.

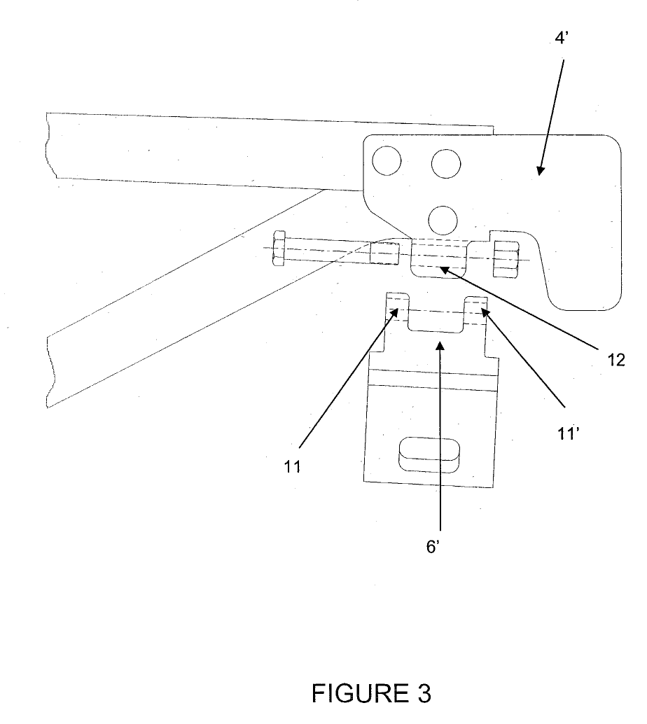

Although it has been described that the brake beam pivoting means comprises a pair of bushings 7, 7′, and that the brake head pivoting means comprise a bushing 8 lodged between the bushings 7, 7′ of the brake beam pivoting means, in an alternative embodiment shown in FIG. 3, the brake head pivoting means may be comprised of a pair of bushings 11, 11′ welded along the brake head's inclined superior surfaces 6, 6′, and the brake beam pivoting means may be comprised by a bushing 12 lodged between the bushings 11, 11′ of the brake head pivoting means.

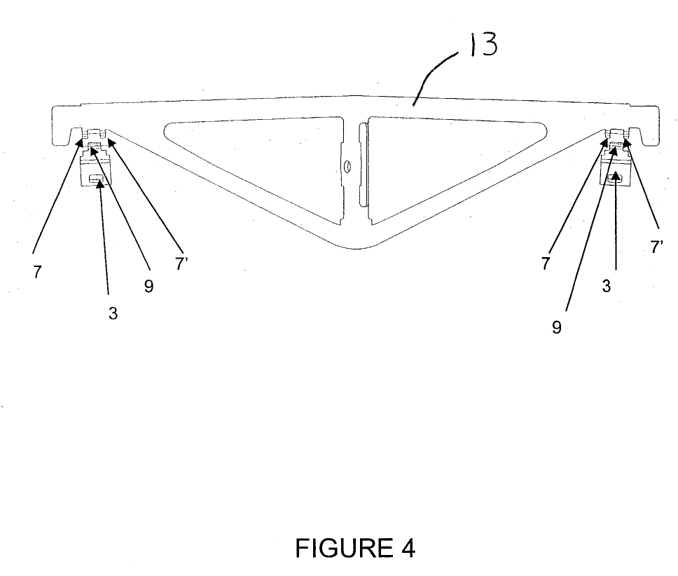

Furthermore, although it has been described that the brake beam pivoting means are welded to the brake beam extensions 4, 4′, it may be possible to cast the brake beam together with the brake beam pivoting means as a single unitary member 13, as shown in FIG. 4.

Finally it must be understood that the pivoting joint for pivotally joining a brake head to a brake beam of the present invention is not limited exclusively to the above described and illustrated embodiments and that persons having ordinary skill in the art, with the teaching provided by this invention, can make modifications to the design and component distribution of the pivoting joint for pivotally joining a brake head to a brake beam of the present invention, which will clearly be within the true inventive concept and scope of the invention which is claimed in the following claims.

What is claimed is:

1. A pivoting joint for pivotally joining a brake head to a brake beam, wherein the brake beam has a tension member, a compression member, a fulcrum, two ends, and two end extensions, each end extension receiving a respective brake head, and wherein the brake head includes a left inclined superior surface and a right inclined superior surface, and includes linking means for linking the brake head to the brake beam and a brake shoe, the pivoting joint comprising:
brake beam pivoting means for pivotally joining the brake head to the brake beam; and
brake head pivoting means for pivotally joining the brake head to the brake beam pivoting means.

2. A pivoting joint for pivotally joining a brake head to a brake beam according to claim 1, wherein the brake beam pivoting means includes a pair of bushings each welded to at least one of the brake beam extensions.

3. A pivoting joint for pivotally joining a brake head to a brake beam according to claim 1, wherein the brake head pivoting means includes a bushing welded along the brake head's inclined superior surfaces.

4. A pivoting joint for pivotally joining a brake head to a brake beam according to claim 1, further comprising a screw;
wherein the brake beam pivoting means includes a pair of bushings each welded to at least one of the brake beam extensions;
wherein the brake head pivoting means includes a bushing welded along the brake head's inclined superior surfaces and lodged between the bushings of the brake beam pivoting means; and
wherein the screw passes through the bushings of the brake beam and brake head pivoting means and is secured by a nut, thus pivotally linking the brake head to the brake beam.

5. A pivoting joint for pivotally joining a brake head to a brake beam according to claim 1, wherein the brake beam pivoting means includes a bushing welded to at least one of the brake beam extensions.

6. A pivoting joint for pivotally joining a brake head to a brake beam according to claim 1, wherein the brake head pivoting means includes a pair of bushings each welded along the brake head's inclined superior surfaces.

7. A pivoting joint for pivotally joining a brake head to a brake beam according to claim 1, further comprising a screw;
wherein the brake head pivoting means includes a pair of bushings each welded along the brake head's inclined superior surfaces;
wherein the brake beam pivoting means includes a bushing welded to at least one of the brake beam extensions and lodged between the bushings of the brake head pivoting means; and
wherein the screw passes through the bushings of the brake beam and brake head pivoting means and is secured by a nut, thus pivotally linking the brake head to the brake beam.

8. A pivoting joint for pivotally joining a brake head to a brake beam according to claim 1, wherein the brake beam fulcrum, extensions, compression member, and tension member are cast together with the brake beam pivoting means as a single unitary member.
